(19) United States
(12) Patent Application Publication
(10) Pub. No.: US 2008/0039673 A1
(43) Pub. Date: Feb. 14, 2008

(54) Method For Underground Storage Of Ecologically Hazardous Agents And Device For Carrying Out Said Method

(76) Inventor: Lev Nikolaevich Maksimov, Novosibirsk (RU)

Correspondence Address: PAULEY PETERSEN & ERICKSON, 2800 WEST HIGGINS ROAD, SUITE 365, HOFFMAN ESTATES, IL, 60195, US

(21) Appl. No.: 10/590,802

(22) PCT Filed: Feb. 17, 2005
(86) PCT No.: PCT/RU05/00069

§ 371 Date: Jun. 19, 2007

(30) Foreign Application Priority Data
Feb. 25, 2004 (RU) 2004105195

(51) Int. Cl. G21F 9/24; G21F 9/34

(52) U.S. Cl. 588/250; 405/55

(57) ABSTRACT

A method for storing ecologically dangerous substances underground and an apparatus for accomplishing the method. These substances can be radioactive waste, spent fuel elements, nuclear warheads, weapons-grade uranium and plutonium, in all forms, as well as chemical weapons and many other toxic substances, including biologically dangerous substances. Also, this invention can be used for storing many other, specific storage objects, preferably particularly valuable metals, minerals and jewelry produced from same, as well as valuable papers, banknotes, archive contents and historical documents which are to be stored for a long time, etc. Storage takes place in a storage site having deep underground boreholes, by a special gas-hydrodynamic system and by remote control of all the necessary deep loading and unloading operations without using conventional mechanical loading and unloading devices such as shaft elevators, lifts and the like which substantially restrict the range of application of underground storage sites. Unauthorized access to the storage objects is excluded and nuclear and radiation safety is guaranteed in the storage of, for example, radioactive waste, spent fuel elements and also weapons-grade uranium and plutonium, as well as the safety of stocks of chemical weapons and/or their dangerous components as well as of many other toxic substances, and the fire safety of the underground storage zone and storage costs are reduced.

### BACKGROUND OF THE INVENTION

1. Field of the Invention

This invention relates to the storage of various types of substances and specific objects, mainly for storing ecologically dangerous substances and/or products which contain such substances, especially for storing radioactive waste, spent fuel elements, nuclear warheads made of weapons-grade uranium and plutonium in any form as well as chemical weapons and many other toxic substances including biologically dangerous substances. This invention can be used for storing many other specific objects, for example particularly valuable metals, minerals and jewelry produced from same as well as valuable papers, banknotes, archive contents and historical documents etc. which are stored for a long time.

2. Discussion of Related Art

The disclosure in Russian Patent Reference RU 2193799, entitled “Storage site for fission materials” describes background information related to the method and the apparatus according to this invention. The storage site according to this invention is in the form of a type of shaft and contains containers with spaced-apart accommodation of fission materials in vertical nests in the solid reinforced concrete structure of the storage site. The containers have an elongated cylindrical shape with a length which exceeds the diameter of the container by more than an order of magnitude. The framework of the storage site has the form of spacing metal blocks with openings for the vertical storage nests and/or metal pipes with spacer blocks which form a cellular metal matrix with an interior around the storage nests of the fission materials. The interior is filled with concrete and a batch of substances which ensure high absorption capacity for neutrons. The metal spacer blocks have depressions for the concrete arrangement with the neutron absorber.

But with this type of storage and with accommodating storage objects in chambers, considerable underground excavations are necessary. Because this method involves spatially distributed storage sites corresponding to the containers, loading and unloading mechanisms also have to be used. This all leads to complications and to an increase in the expense of the material storage as well as to an inadequate storage safety of the ecologically dangerous substances.

### SUMMARY OF THE INVENTION

This invention is intended to fulfil the following tasks objects:

unauthorized access to the storage objects should be excluded;

practical realization of any conceivable and important scenarios of terror threats should be excluded;

absolute nuclear and radiation security in the storage of, for example, radioactive waste, spent fuel elements, nuclear warheads as well as weapons-grade uranium and plutonium should be achieved;

extremely secure storage of, for example, residues of chemical weapons and/or their dangerous components as well as of other toxic substances should be achieved;

complete protection for the storage objects against all known air attacks of a potential assailant should be achieved;

absolute fire safety in the zone of the underground storage should be achieved; and

the storage costs should be reduced in comparison with known storage sites, and not only are ecologically dangerous substances to be stored but also other specific storage objects, especially, for example, valuable metals, minerals and jewelry produced from the same, as well as valuable papers, banknotes, archive documents to be stored for a long time.

One problem is solved with a method for storing underground ecologically dangerous substances which are located in a container and/or in products containing such substances, as well as other specific storage objects. In one method of this invention, the storage takes place in deep boreholes and/or shafts, the pipe liners of which are hermetically sealed and the storage objects are introduced into the pipe liners via lock devices which are known. The storage objects are previously placed in technological secondary containers which are open at the bottom and represent structurally altered caissons. Furthermore, the caissons, with the storage objects already placed in them, are placed one on top of the other inside a pipe liner of a loading borehole. However, this is not carried out with the aid of a conventional mechanical device, for example with shaft elevators, lifts and the like, which are provided for conveying known underground objects, but rather for the practical realization of all the necessary loading and unloading operations inside the borehole a gas-hydrodynamic complex system is used. With the aid of this complex system, the actions are described in detail further, and structural elements and functional subsystems are controlled remotely and specifically so that no mechanical devices are required to be introduced into the borehole interior. All the necessary technological operations, such as the complete loading of the borehole with the storage objects and the unloading of the borehole, are carried out, these operations being realized in principle without restricting the capacity of the underground storage sites and of the borehole depth, which is measured in kilometres.

According to this invention, the gas-hydrodynamic complex system combines functionally three main system groups, including a hydraulic subsystem and a gas subsystem using known, perfected devices and a third subsystem into which the known lock device or a structurally perfected lock device for specific storage objects is received. The above-mentioned technological secondary containers externally resemble caissons but are designed with a specific special structural feature; in these secondary containers, the functionally most important action is carried out, namely a target calculation in which the value of the positive buoyancy of the caissons used with the storage objects arranged in them is controlled remotely. In this process, such an action is in principle realized at any depth of the following forced immersion into a random fluid medium with which the borehole is previously filled.

With the aid of the created gas-hydrodynamic system, the remote-controlled loading of the borehole storage site with the technological secondary containers is realized. First, however, the entire interior of the sealed borehole pipe liner, even up to where it emerges from the above-mentioned hydraulic subsystem, is filled with some technological fluid, for example with water or some other fluid which is especially most compatible chemically with the stored substances and materials which are used overall in the construction of the storage site. Then, with the aid of the above-mentioned third subsystem, the lower caisson is introduced first via the lock device into the borehole which is flooded by the fluid, and this lower caisson has the special feature that no storage objects are placed in it and that it can be constructed to maintain positive buoyancy right up to maximum immersion directly to the bottom of the borehole. Also, the above-mentioned caisson is plunged into the technological fluid in the borehole because on top of it is placed, again with the aid of the lock device having an appropriate ram, the second technological caisson with storage objects in it and at a relatively lower value of the original desired positive buoyancy. Then the third caisson is placed in a similar manner and the end result is that the entire calculated set of caissons is submerged in the technological fluid located inside the bore and correspondingly the technological fluid displaced from the borehole is led to an external collector of the hydraulic subsystem or into some other, for example adjoining, borehole which is prepared for future loading or which is located in the unloading area. During the above-mentioned actions, however, the reduction of the summary positive buoyancy arising according to the submersion of the caissons, of the entire vertical caisson assembly provided is constantly monitored. Then the value is maintained by computer because the above-mentioned gas subsystem starts and in air or some other chemically preferred gas for the storage objects, for example nitrogen, argon or helium, is led through the layer of technological fluid into the lower caisson on the basis of the calculated depths inside the borehole. With the above-mentioned inter-connected actions the provided positive buoyancy of the entire vertical caisson assembly is maintained according to its submersion until the lower caisson strikes the borehole bottom. Thus, the calculated remote-controlled loading of the borehole with the caissons having the storage objects in them is terminated.

So that in the borehole storage site the condition of “dry” storage is created, on termination of the loading of the deep borehole, the mouth of the bore is sealed airtight with an appropriate blocking device, using the created gas-hydrodynamic control system as mentioned above, and gas is led into the interior of the pipe liner from the above-mentioned gas subsystem, under such pressure that the earlier used technological fluid is removed in a guaranteed manner from the interior of the borehole by “pressing out” through peripheral pipe ducts which are secured for this purpose to the lower base portion of the borehole, and thus communicating vessels of sorts are produced. After this final removal of the technological fluid into external collectors, the above-mentioned pipe ducts are also hermetically sealed. Inside the storage borehole, a technologically recommended excess pressure is generated of that gas which is also selected for technological reasons for the completed formation of the appropriately “dry” protective atmosphere in the borehole storage site.

The processes of unloading from the borehole storage site the caisson containing the storage objects, using the created gas-hydrodynamic system, are realized because first, in the borehole, the pressure of the gas protective atmosphere previously established in it is lowered to the calculated value, for example to the external atmospheric pressure, and thereafter, from the hydraulic subsystem the borehole is filled with the technological fluid in its base portion, for which purpose the above-mentioned peripheral pipe ducts are used. Simultaneously, also from the base portion, a sparging gas is led from the gas subsystem into the lower caisson which is so designed that the gas also flows in turn into all the caissons arranged on top. Thus, in the entire vertical caisson assembly the calculated positive buoyancy is created as a result of which the controlled general rising of the entire caisson column up to the upper level of the borehole mouth and/or up to the entrance into the lock device is also caused, out of which the caissons are guided cyclically by appropriate gripping mechanisms into the control rooms. Thus inside the underground storage site, an equipment check of the caissons and the storage objects located in them is guaranteed for formulating a summary decision or for extending the deep storage time, for some of them, for example in the adjoining borehole storage site or for delivering storage objects to be removed from the bunker according to a corresponding stipulation, for example for technological processing.

In those cases in which heat must be dissipated from the storage objects, for example from the radioactive waste or from the spent fuel elements and also from weapons-grade plutonium and other radioactive materials, in the construction of the borehole storage site the known physical effect of “super heat conductivity” is realized. Furthermore, inside the borehole is arranged a so-called heat pipe with heat dissipation onto the inner wall of the upper region of the borehole pipe and/or through its walls onto external heat exchangers. Furthermore, the necessary gas pressure for this is correspondingly set in the protective atmosphere inside the borehole.

Particularly dangerous storage objects, for example nuclear fission materials are loaded into technological caissons of a most secure type, for which purpose the elongated cylindrical containers are used, as disclosed in Russian Patent Reference RU 2193799 entitled “Storage sites of fission materials”.

The accomplished loading of the storage objects, for example the nuclear fission materials, is protected against the external physical influence not only with the appropriate submersion in the borehole but also with the use of known protective materials, for example lithium hydride, gadolinium, lead and others, in the loading of the upper caissons, and on this basis the so-called shadow protection against external neutron radiation and/or hard gamma radiation is created.

Inside the underground bunker, two or more borehole storage sites are created, the lock devices of which are united by the transport corridors with a general robot chamber for the remote-controlled overall equipment check for the caissons and the storage objects contained in same, as well as with a general zone for receiving into the underground bunker and for delivering from this bunker the caissons having actual storage objects.

For the practically complete exclusion of unauthorized access to the storage objects which are located in the borehole storage sites, after loading of the storage objects and after the borehole mouth is hermetically sealed, the lock devices used are dismantled and removed from the underground bunker to be accommodated in an external central store, the work processes being able to be carried out in other uniform storage sites at least temporarily. Furthermore, the gas-hydrodynamic guiding system is placed for example on a car transport trailer, which is moved to a location of actual borehole storage sites only for the time needed to carry out the sanctioned scheduled work and then this guiding system is also moved into the above-mentioned central store.

When a borehole storage site of relatively small depth is used it is possible to use, instead of the above-mentioned caissons through which gas is blown, pontoon-like airtight floating tanks to which the storage objects are fastened. All procedures of loading and unloading the borehole are then realized with limited use of the above-mentioned gas subsystem only for “pressing” the technological fluid out of the borehole in the case of the expedient creation of “dry” storage.

For reducing the value of the force which is necessary for plunging the caissons or floating pontoons containing the storage objects into the technological fluid of the borehole storage site, some of the above-mentioned fluid is removed externally from the borehole using an appropriate pump, the amount corresponding for example to the volume of the next object plunging into this fluid.

The value of the general positive buoyancy, which is produced by the vertical assembly of the caissons and which naturally reduces with increasing immersion in the technological fluid, is controlled remotely, the value of the force being measured and calculated which acts for example from the side by the ram of the lock device during the above-mentioned vertical assembly of the caissons created by the cyclical submersion.

For providing remote-controlled monitoring of the borehole storage site, after termination of the sanctioned work on the borehole storage site, the underground bunker is hermetically sealed and in this location, as well as directly in the borehole, a recommended excess gas pressure is created technologically and structurally, the input value of which is held and then continues to be automatically maintained for example via radio channels from a central protection support point.

The apparatus of the storage site for accomplishing the above-mentioned method for storing underground, for example, ecologically dangerous substances is equipped with a borehole and a borehole pipe or column, or with a shaft column which has a corresponding pipe column or contains a plurality of individual boreholes with their pipe columns fixed into its walls. In all cases, however, the base of the borehole pipes is hermetically sealed. Over the mouth of the individual borehole in question, in order to simplify, is mounted an underground bunker, in which is arranged the lock device for carrying out the external loading and unloading with the technological secondary containers used, in the form of caissons, in which the storage objects themselves are accommodated. Here, inside the borehole, in addition to its borehole pipe, there is mounted a technological pipe column on the outer side of which pipe ducts are secured. Some of the pipe ducts are connected to the hydraulic subsystem and the other pipe ducts are connected to the gas subsystem. All these components, including the accompanying structural elements, which will be described in detail later, are functionally combined in the stock of the created complex gas-hydrodynamic system for the remote control and the corresponding provision of all the necessary loading and unloading operations inside the borehole, specifically without using mechanical devices in the underground storage site in question, which would have to be guided into the borehole, for example shaft elevators, lifts and the like, which are usually used for loading and unloading in all known underground storage sites.

According to this invention the gas-hydraulic complex system for the remote-controlled work in the storage sites comprises three main subsystems, specifically the hydraulic subsystem and the gas subsystem, each of which is equipped with known functional elements, especially with hydraulic pumps and gas compressors having appropriate valve fittings. These two subsystems are arranged outside the underground bunker, for example on the base of a car trailer, and are connected to the general control complex only for the duration of the sanctioned work. The third subsystem is arranged inside the borehole storage site and includes the lock device of a known type or of a type matched to the actual storage objects as well as the set of technological secondary containers in the form of caissons, but with differentiating features which will be described in detail later. The storage objects are arranged directly in these special caissons.

The technological secondary containers in the form of caissons as part of the above-mentioned third functional subsystem are so designed that each caisson has an upper lid with openings to which inner injection pipes, immersion pipes, are connected from below in an airtight manner. The lower end of the injection pipes is arranged in front of the lower lid of the caisson, which itself also has openings, and the centers of the openings lie one above the other perpendicular to the centers of the openings on the upper lid of the caisson. Also, the storage objects are secured between these lids which are connected to a cylindrical outer wall inside the above-mentioned caissons.

The lowermost caisson is designed with the greatest calculated buoyancy, the positive importance of which is guaranteed structurally at all levels of its submersion until it rests on the bottom of the borehole. Also, no storage objects are secured in this caisson and it has a central support platform and a hydraulic damper.

In the base region of the borehole, some of those pipe ducts which are mounted on the technological borehole pipe column and connected in their upper region to the hydraulic subsystem, are secured by their lower ends to the base plane of the pipe liner. The ducts form with the inner circumference of the borehole communicating vessels of sorts and the other pipe ducts, which are connected to the external gas subsystem, have at their lower ends with angular apertures or nozzles for the sparging gas supplied in a jet through the technological fluid in the lower caisson. Furthermore, through the lower caisson the gas is guided continuously into all the higher arranged caissons which are provided with storage objects. Here, particularly deep boreholes are provided, having a plurality of intermediate zones for blowing gas through the lower caisson which are distributed in the depth of the borehole. These intermediate zones are equipped with corresponding gas ducts which also have lower angular apertures or nozzles for a similar way of supplying the sparging gas to the lower caisson. For example, during its submersion in and movement towards precisely such intermediate zones.

One or more pipe ducts, which are connected to the hydraulic subsystem, are connected to a separate pumping unit for periodically pumping the technological fluid out of the borehole from the submersion plane, which is less than the size of the barometric column of the above-mentioned fluid.

In the plane of the borehole mouth, in front of its sealed upper blocking closure, sliding supports, for example some type of one-sided latch arrangements, are secured to prevent any uncontrollable rising of the loaded upper caisson and for the overall mounting of the caissons in the zone of the arrangement of the lower blocking closure of the lock device.

The method and the corresponding apparatus of the underground storage site according to this invention are explained with the aid of a brief consideration in the first place of the support point concepts used in the invention and the technological operations required by these, as well as on the basis of the basically novel totality of the main functional subsystems created for this and their main structural elements.

Altogether, underground storage is proposed, for example, the above-mentioned ecologically particularly dangerous substances and also other specific storage objects which are located in appropriate packaging and/or are open products which are taken into specially created deep boreholes or into deep boreholes which have been taken out of operation but appropriately reconstructed for re-use. Also, it is possible to use, for the creation of the storage sites according to this invention, for example, those shafts which originate from the previous operation of some other underground structures. Here a variant is possible in which a plurality of separate pipe liners or immersion pipes are fixed into the large-area shafts, which form appropriate borehole storage sites but can be used without the traditional drilling of boreholes. Thus, it is possible to form underground storage sites according to this invention, for example in canyons and also in deep-sea trenches and the like. In all cases, however, conceptually the obligatory sealing of the corresponding pipe liners is required. This is the first support point concept in the realization of this invention.

The creation of a special gas-hydrodynamic system for the underground storage sites according to this invention is regarded as a second and important key concept. This system can completely exclude the use of mechanical loading and unloading devices, which penetrate the underground structures for operating the same. For example, the conventionally used, manifold shaft elevators, lifts and the like. The basically most important difference and one advantage of this invention, as compared with all known underground storage sites, relates to the exclusion of the above-mentioned conventional mechanical devices which ensures the success of the above-mentioned technical objectives in the realization of this invention.

The above-mentioned gas-hydrodynamic complex system comprises three main subsystems which are within functionally united. The hydraulic subsystem and the gas subsystem, using known devices, and the third special subsystem which includes the lock device of a known type but which is structurally matched to actual storage objects, and also includes a set of technological secondary containers which resemble the caissons externally but are embodied structurally with a substantially different feature. This feature includes that when storage objects are accommodated in such caissons and the gas-hydrodynamic system created is then started, there exists overall the possibility of supporting by remote control, with the input calculation, the level of the positive buoyancy of the above-mentioned caissons during their forced submersion in a fluid medium which fills the borehole.

### BRIEF DESCRIPTION OF THE DRAWINGS

This invention is explained in view of embodiments and drawings, wherein:

FIG. 1 is a schematic longitudinal section taken through a borehole storage site;

FIG. 2 is a longitudinal section taken through a part of the airtight base portion of the storage borehole with the lower caisson;

FIG. 3 is a longitudinal section taken through a portion of the borehole and of a lower caisson in an illustrated intermediate zone through which gas is blown;

FIG. 4 is a section taken through part of a caisson coupling zone with the effect of the gas-hydrodynamic system;

FIG. 5 is a longitudinal section taken through a portion of the storage site borehole with vertically accommodated caissons;

FIG. 6 is a longitudinal section taken through the lower caisson and the technological storage caisson arranged above the same;

FIG. 7 is a plan view of the upper lid of the caisson;

FIG. 8 is a cross-section of the caisson with the storage object arranged in same;

FIG. 9 is a bottom view of the lower lid of the caisson;

FIG. 10 is a longitudinal section of part of the zone through which gas is blown in the lower caisson;

FIG. 11 is a wall cross-section of a portion of the caisson and of the storage borehole; and

FIG. 12 is a cross-section taken through the borehole in the zone through which gas is blown in the lower caisson.

### DETAILED DESCRIPTION OF THE INVENTION

The appended drawings show, for explanation of the method and the apparatus for accomplishing the method, the following main structural and functional elements:
1. underground bunker,
2. conditionally quoted lock device,
3. mouth of the storage borehole,
4. upper region of the storage borehole,
5. conditionally quoted upper level of the caissons with protective covering materials of the storage site,
6. conditional, upper level of the loading of the borehole with caissons having the storage objects,
7. cylindrical wall (console) of the caisson,
8. upper lid of the caisson,
9. immersion pipe of the caisson,
10. pipe liner (drilling tower) of the borehole,
11. solid concrete,
12. conditionally shown caisson with the storage objects,
13. surrounding geological rock,
14. one of the intermediate zones through which gas is blown,
15. immersion pipe exit of the gas from the caisson,
16. the gas zone of the caisson,
17. gas/fluid boundary in the caisson,
18. lower section of the immersion pipe of the caisson,
19. immersion pipe entrance for the gas into the caisson,
20. lower lid of the caisson,
21. lower caisson,
22. hydraulic damper,
23. lower support pillar,
24. lower zone through which gas is blown,
25. base of the pipe liner of the borehole,
26. upper openings of the immersion pipes of the caisson,
27. storage object secured in the caisson,
28. openings of the lower entrance for the gas into the caisson,
29. pipe duct through which gas is blown in the lower caisson,
30. angular aperture of the jet supply of the gas into the lower caisson,
31. heat insulation layer and/or capillary cooling system layer,
32. pipe ducts for the base supply of the technological fluid and its return conveyance,
33. technological pipe tower (double pipe) of the borehole.

A created gas-hydrodynamic complex system and its functioning is explained in detail with the main parts of the practical realization of this invention following below and with the appended drawings.

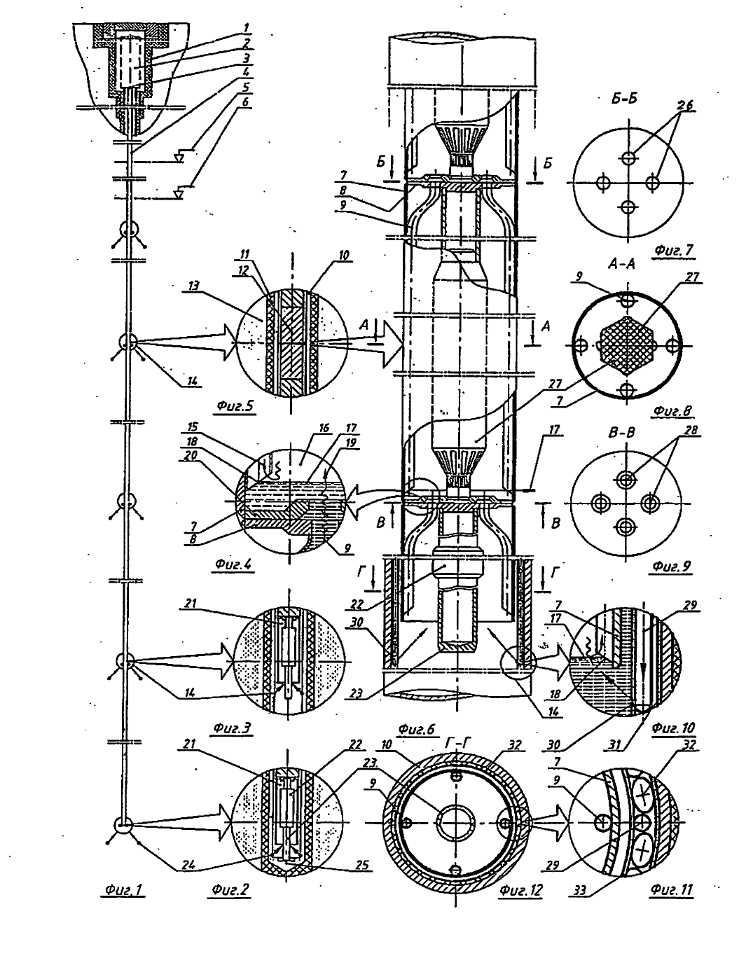

As apparent from FIG. 1, the proposed underground storage site is created by using a bunker 1 and a lock device 2 incorporated in the same over the mouth of a borehole 3 with a given upper portion 4 and a pipe liner 10, which in principle leads into an unlimited depth. Technological containers 12 which are called “caissons” and in which the storage objects are accommodated, are placed in the stock of the above-mentioned third subsystem inside the pipe liner in a vertical set (see FIGS. 2 and 5) above a special lower caisson.

Structurally, the technological caissons (see FIG. 6) have an upper lid 8 having openings 26 which are connected airtight to immersion pipes 9, the lower end 18 of which lies in front of a lower lid 20 having openings 28 for the lower entry of gas into the caisson. The vertical axes of these openings lie with the openings 26 in the upper lid, one above the other. The above-mentioned lids are secured to the cylindrical outer wall 7 of the caisson and in the caisson are directly located storage objects 27.

The lower caisson 21 is only equipped with the upper lid, exactly as in the technological caissons, and is equipped inside with similar immersion pipes 9, but in contrast to the other caissons, no storage objects are arranged in caisson 21 but a lower steady support 23 with a hydraulic damper 22 (see FIGS. 2 and 6).

Inside the pipe liner 10 is installed a technological circulation double pipe 33 in which pipe ducts 32 are arranged, some of which are connected at the top to the hydraulic subsystem and with their lower ends are introduced into a base zone 25. Other gas ducts 29, however, are connected at the top to the gas subsystem and at their lower end they have angular apertures or nozzles 30 for delivery of a jet of gas into the lower caisson in the above-mentioned base zone 24 and also in the intermediate zones 14 which are adjusted to the calculated marks according to the depth of the borehole.

The inner surface of the pipe liner 10 also has a heat insulation layer 31 and/or a capillary cooling system.

With the aid of the created gas-hydrodynamic system, remote-controlled loading of the borehole storage site with the technological auxiliary caissons is realized. First, the entire interior of the sealed pipe liner 10 of the borehole, even up to where it emerges 3 from the above-mentioned hydraulic subsystem, is filled with some technological fluid, for example water or some other fluid, which is chemically most suitable for the stored substances and materials which are used overall in the construction of the storage site.

Then, with the aid of the third subsystem, which is also mentioned in the claims, first the lower caisson 21 is introduced via the lock device into the borehole flooded by the fluid. The caisson 21 has a special feature that no storage objects are arranged in it and this caisson is constructed to retain positive buoyancy right up to maximum immersion directly to the bottom of the borehole 25. The above-mentioned caisson is plunged into the technological fluid in the borehole and, from above, the second technological caisson 7 with the storage objects 27 in it is placed on it, again with the aid of the lock device having an appropriate ram. The second caisson 7 having a relatively smaller value, input for it structurally, of the original positive buoyancy. Then the third caisson is introduced in a similar manner etc. In this way, the entire calculated set of caissons 12 is submerged in the technological fluid which is located inside the borehole.

The technological fluid which is thereby displaced from the borehole is led to an external collector of the hydraulic subsystem or into some other, for example adjoining, borehole which is prepared for future loading or which is located in the unloading area.

During the above-mentioned actions, the lowering of the summary positive buoyancy, produced according to the submersion of the caissons, of the entire added vertical assembly of the caissons is constantly monitored and then the value is obtained by calculation in that the above-mentioned gas subsystem is started and in that, at the calculated depths 14, 24 inside the borehole, air or some other chemically preferred gas for the storage objects, for example nitrogen, argon or helium is led through the layer of technological fluid into the lower caisson.

With the above-mentioned interconnected actions, the input positive buoyancy of the entire added vertical assembly of the caissons is held, according to their submersion, until the lower caisson 21 strikes the borehole bottom 25, and the calculated remote-controlled loading of the borehole with the caissons having the storage objects arranged in them is terminated.

In those cases in which the creation of the condition of “dry” storage in the borehole storage site for actual storage objects is expedient, on completion of the loading of the borehole, using the created gas-hydrodynamic control system as mentioned above, the mouth 3 of the borehole is sealed airtight with an appropriate blocking device. Then gas is led into the interior of the pipe liner from the above-mentioned gas subsystem under such a pressure that the removal of the previously used technological fluid from the interior of the borehole is guaranteed by “pressing out” towards the outside through the peripheral pipe ducts 32. For this purpose, the above-mentioned ducts having the depression are secured to the lower base portion 25 of the borehole, thus producing communicating vessels of sorts.

After this final removal of the technological fluid into the external collectors, the pipe ducts are also hermetically sealed. Also, inside the storage borehole, a technologically recommended, calculated excess pressure of that gas is fixed which is also selected for technological reasons for the completed formation of the correspondingly “dry” protective atmosphere in the borehole storage site.

The processes of unloading the caissons having the storage objects from the borehole storage site are realized using the created gas-hydrodynamic system as follows.

First, in the borehole, the pressure of the gas protective atmosphere earlier established in same is lowered to the calculated value, for example to the external atmospheric pressure. Then, from the hydraulic subsystem the base portion of the borehole is filled with the technological fluid, for which purpose the above-mentioned peripheral pipe ducts are used.

Simultaneously, sparging gas is conveyed from the gas subsystem into the lower caisson 21, also starting from the base portion 24. The design of this caisson is such that the gas entering through the lower cross-section 18 of the immersion pipes 9 from a gas buffer zone 16 displaces downward the gas/fluid boundary 17 in the caisson and goes in a direction 15 through the pipes 9 and onward in a direction 19 into entry apertures 28 of the buffer zone 16 already in the technological caissons arranged higher.

In this way, the gas flows successively into the entire vertical assembly of the caissons and creates that calculated positive buoyancy on the basis of which is produced the controlled general rising of the entire column of caissons up to the upper level of the borehole mouth and/or up to the entrance into the lock device 2. From it the caissons are guided out cyclically with gripping mechanisms in control rooms, by which an equipment check of the caissons and of the storage objects located in same is guaranteed inside the underground bunker 1.

In this phase, a decision is made as to whether some of the objects will continue to be deep-stored, for example in the adjoining borehole storage site, or whether the actual storage objects are to be taken out of the bunker in accordance with a corresponding stipulation, for example for technological processing.

In those cases in which heat absolutely must be dissipated from the storage objects, for example from the radioactive waste or from the spent fuel elements as well as from the weapons-grade plutonium and other radioactive materials, in the construction of the borehole storage site the known physical effect of “super heat conductivity” is used, and inside the borehole a so-called heat pipe is realized with heat dissipation, using an appropriate lower capillary layer 31, onto the inner wall of the upper region 4 of the pipe liner 10 and/or through its walls onto the external heat exchangers, and correspondingly the necessary gas pressure for this purpose is set in the protective atmosphere inside the borehole.

In the case in which the storage objects represent a particular danger in themselves, for example nuclear fission materials including weapons-grade uranium and/or plutonium, they are loaded into the technological caissons in their original containers of the most secure type. Thus, elongated cylindrical containers are used, for example, which are disclosed in Russian Patent Reference RU 2193799 entitled “Storage sites of fission materials”.

The loading of the nuclear fission materials in the storage site according to this invention is protected against external physical influences not only with the appropriate submersion in the borehole, as far as level 6, conditionally shown in FIG. 1, but also by known protective materials, for example lithium hydride, boron carbide, gadolinium, lead and others, as used in the loading of the upper caisson, and on this basis the so-called shadow protection, as far as the conditionally quoted level 5, against external neutron radiation and/or hard gamma radiation is created.

Inside the underground bunker 1 used, two or more borehole storage sites of the considered type are created, the lock devices of which are united by the transport corridors with a general robot chamber for the remote-controlled overall equipment check of the caissons and of the storage objects contained therein, as well as with a general zone for receiving into the underground bunker and for delivering out of the bunker the caissons with the actual storage objects in them.

For the practically complete exclusion of unauthorized access to the storage objects which are located in the borehole storage sites, after the objects are loaded and after the borehole mouth is hermetically sealed, the lock devices used are dismantled and removed from the underground bunker. The lock devices are then accommodated in a central external store and are also used temporarily for carrying out work processes in other uniform storage sites. To the same end, the gas-hydrodynamic guiding system is transported, for example by a car transport trailer, and is brought to the location of actual borehole storage sites only for the time necessary to carry out the sanctioned scheduled work. On termination of the work, the above-mentioned system is also brought into the central store.

When a borehole storage site of comparatively small depth is used, it is possible to use pontoon-like, airtight floating tanks instead of the above-mentioned technological caissons 12 through which gas is blown, on which floating tanks the storage objects are secured, all the procedures of loading and unloading the borehole being carried out with limited use of the gas subsystem only for “pressing” the technological fluid out of the borehole in the case of the expedient creation of “dry” storage.

For reducing the value of the force which is necessary for immersing the caissons or floating pontoons containing the storage objects into the technological fluid of the borehole storage site, there is external removal from the borehole, for example through one or more ducts 32, of some of the above-mentioned fluid using an appropriate pump, the amount corresponding for example to the volume of the next object plunging into this fluid.

The value of the positive buoyancy while loading the borehole with the vertical caisson assembly 12, which reduces with increasing lowering of the caissons into the technological fluid, is measured with the appropriate determination of the value of the force which occurs for example from the side of the ram of the lock device 2 during the cyclical lowering of the formed vertical caisson assembly.

For carrying out the remote-controlled monitoring of the borehole storage site, on termination of the sanctioned work on this site the underground bunker is hermetically sealed, and in this location as also directly in the borehole, technologically and structurally a recommended excess gas pressure is created, the input value of which is held and continues to be maintained automatically, for example via radio channels from a central protection support point.

For preventing uncontrolled rising of the loaded upper caisson and/or of the entire caisson assembly in the zone of the arrangement of the lower blocking closure of the lock device in the plane 3 of the borehole mouth in front of the sealed upper blocking closure as well as also possibly in the plane 5 of the upper loading limit (see FIG. 1), sliding supports, for example some type of one-sided latch arrangements, are secured inside the pipe liner 10.

Altogether, underground storage is proposed of, for example, the above-mentioned ecologically particularly dangerous substances and also of other specific storage objects, which are located in appropriate packaging and/or are open products, in specially created deep boreholes or in deep boreholes which have been taken out of operation but subjected to appropriate reconstruction. Also, it is possible, for the creation of the storage sites according to this invention, to use for example shafts which originate from some previous operation of any kind of underground structures. Here, a variant is possible in which a plurality of separate pipe liners or a pipe liner tower is fitted in the large-area shafts, which form corresponding borehole storage sites but which manage without the conventional drilling of boreholes. In this respect, it is possible to form the underground storage sites according to this invention for example in canyons and also in deep-sea trenches and the like. In all cases, however, conceptually the obligatory sealing of the corresponding pipe liners is required.

This invention is industrially applicable because no special materials, equipment and new technology are necessary for its realization.

1. A method for storing underground cologically dangerous substances which at least one of are located in containers and are open products containing the substances, and an other storage objects, the method comprising:
a storage occurring at least one of in deep boreholes and shafts with borehole pipes sealed and into which the storage objects are brought through a lock device, the storage objects being pre-arranged in technological secondary containers open at a bottom and representing structurally altered caissons, and then the caissons with the storage objects are placed one on top of the other inside a pipe liner in the borehole while avoiding lifts and other conventional mechanical devices, and for operating the underground objects, including all the necessary loading and unloading operations inside the borehole, a gas-hydrodynamic complex system is used and structural elements going into a stock of a system and functional subsystems of the system are controlled remotely.

2. The method according to claim 1, wherein
the gas-hydrodynamic complex system combines functionally three main system groups, including a hydraulic subsystem and a gas subsystem each having devices, and a third subsystem which includes one of a lock device and a structurally perfected lock device for specific storage objects, caissons are designed with a specific structural feature with an action carried out by the gas-hydrodynamic complex system in the caissons, including a target calculation in which a value of a positive buoyancy of the caissons used with the storage objects arranged in them is set by a remote control, which leads to a random depth of a following forced immersion into a random fluid medium with which the borehole is filled.

3. The method according to claim 1, wherein
the gas-hydrodynamic system operates loading of the borehole storage site with the technological caissons so that an entire interior of the sealed borehole pipe liner, even up to a position for emerging from the hydraulic subsystem, is filled with a technological fluid compatible chemically with stored substances and materials used in construction of the storage site,
then the third subsystem first loads the lower caisson via the lock device into the borehole which is flooded by the technological fluid,
the lower caisson is free from the storage objects and is constructed to have a positive buoyancy up to a maximum immersion directly to the bottom of the borehole,
then the lower caisson is plunged into the technological fluid in the borehole,
on top of the lower caisson is placed with the lock device having an appropriate ram a second technological caisson having the storage objects and having a relatively lower value of the positive buoyancy,
the third caisson is placed in a similar manner until the entire calculated set of caissons is submerged in the technological fluid located inside the borehole and the technological fluid which is displaced from the borehole is led into an external collector of one of the hydraulic subsystem another adjoining borehole one of prepared for future loading and located in the unloading area,
a reduced overall positive buoyancy resulting from a submersion of caissons of the entire vertical caisson assembly provided is constantly monitored and then a buoyancy value is obtained by a calculation in view of the monitoring,
then the gas subsystem starts,
into calculated depths inside the borehole one of air and some other chemically preferred gas for the storage objects, including one of nitrogen, argon and helium, is led through a layer of technological fluid into the lower caisson, and
an input positive buoyancy of the entire vertical caisson assembly is maintained according to a submersion until the lower caisson strikes the borehole bottom and a calculated remote-controlled loading of the borehole with the caissons having the storage objects is terminated.

4. The method according to claim 1, wherein
for creating a dry storage condition in the borehole storage site, on termination of loading of the deep borehole, a mouth of the borehole is hermetically sealed with an appropriate blocking device, using the gas-hydrodynamic control system, the
gas is led into an interior of the pipe liner from the gas subsystem under such pressure that removal of the technological fluid used from the interior of the borehole is guaranteed by a pressing out to an outside through peripheral pipe ducts secured to a lower base portion of the borehole and communicating vessels are produced,
then a final removal of the technological fluid into the external collectors peripheral pipe ducts are hermetically sealed, and
inside the borehole a technologically recommended excess pressure is generated of the gas which is selected for technological reasons for a completed formation of an appropriately dry protective atmosphere in the borehole storage site.

5. The method according to claim 1, wherein when
unloading from the borehole storage site the caissons containing the storage objects, using the gas-hydrodynamic system,
first in the borehole the pressure of the gas protective atmosphere previously established is lowered to a calculated value, to the external atmospheric pressure,
from the hydraulic subsystem the borehole is filled with the technological fluid in a base portion by the peripheral pipe ducts are used, and
simultaneously and from the base portion a sparging gas is led from the gas subsystem into the lower caisson so that the gas flows into all the caissons arranged on top, creating in the entire vertical caisson assembly the calculated positive buoyancy resulting at least one of a controlled general rising of an entire caisson column up to at least one of an upper mouth of the borehole an entrance into the lock device, out of which the caissons are guided cyclically by appropriate gripping mechanisms in control rooms, inside an underground bunker an equipment check of the caissons and the storage objects located in them takes place for one of formulating a summary decision and extending the deep storage for technological processing.

6. The method according to claim 1, wherein for dissipating
heat from the storage objects in a construction of the borehole storage site a physical effect of a super heat conductivity is accomplished by the borehole arranged as a heat pipe with a heat dissipation at least one of onto an inner wall of an upper region of the pipe liner and through a wall onto external heat exchangers and correspondingly a necessary gas pressure is set in a protective atmosphere inside the borehole.

7. The method according to claim 1, wherein
dangerous storage objects, are loaded into the technological caissons which are secured containers for which purpose the elongated cylindrical containers are used.

8. The method according to claim 1, wherein an
accomplished loading of the storage objects is protected against an external physical influence with an appropriate submersion into the borehole and with the use of protective materials for loading of the upper caissons, and creating a shadow protection against at least one of external neutron radiation hard gamma radiation.

9. The method according to claim 1, wherein
inside the underground bunker at least two borehole storage sites are created and the lock devices of which are united by transport corridors with a general robot chamber for a remote-controlled overall equipment check for the caissons and the storage objects and with a general zone for receiving into the underground bunker and for delivering from the bunker the caissons having the storage objects.

10. The method according to claim 1, wherein for a nearly
complete exclusion of unauthorised access to the storage objects located in the borehole storage sites, after loading and hermetic sealing of the borehole mouth, the lock devices are dismantled and removed from the underground bunker to be in an external central store, possibly being temporarily accommodated in other uniform storage sites for work processes to be carried out, and the gas-hydrodynamic guiding system is arranged on a vehicle which is moved to the location of the actual borehole storage sites only for a time needed to carry out the sanctioned scheduled work and is then moved to the above-mentioned central store.

11. The method according to claim 1, wherein
when the borehole storage site of relatively small depth is used pontoon-like airtight floating tanks to which the storage objects are fastened and the gas subsystem the technological fluid out of the borehole in the dry storage.

12. The method according to claim 1, wherein
for reducing a value of a force necessary for plunging one of the caissons and the floating pontoons into the technological fluid of the borehole storage site, some of the technological fluid is removed externally from the borehole using a pump, and an amount corresponding to a volume of a next object plunging into the technological fluid.

13. The method according to claim 1, wherein
a value of a general positive buoyancy produced by the vertical assembly of the caissons and which reduces with increasing immersion in the technological fluid, is measured by calculating remotely a value of a force produced from a side with a ram of the lock device during vertical assembly of the caissons created during the cyclical submersion.

14. The method according to claim 1, wherein
for carrying out a remote-controlled monitoring of the borehole storage site, after termination of work, an underground bunker is hermetically sealed and in the underground bunker and directly in the borehole a recommended excess gas pressure is generated technologically and structurally, and a provided level is held and then continues to be automatically maintained via radio channels from a central protection support point.

15. The method according to claim 1, wherein for storing underground ecologically dangerous substances,
an apparatus comprises one of a borehole pipe and a shaft column with one of a corresponding pipe column and a plurality of individual boreholes with pipe towers fixed into walls, the base of the borehole pipes being hermetically sealable and there being fastened over a mouth of the borehole an underground bunker in which the lock device for carrying out external loading and unloading is arranged with the technological secondary containers, in the form of caissons, in which the storage objects are accommodated, and inside the borehole a borehole pipe and a technological pipe column are fastened on an outer side of which pipe ducts are secured, of which some are connected to the hydraulic subsystem and the remainder to the gas subsystem, including accompanying structural elements which are constituent parts of the complex gas-hydrodynamic system created.

16. The apparatus for the method according to claim 15, wherein
the gas-hydraulic complex system for remote-controlled work in the storage sites comprises three main subsystems including the hydraulic subsystem and the gas subsystem which are both equipped with functional elements, including hydraulic pumps and gas compressors having appropriate valve fittings, are fastened outside the underground bunker and are connected to a general control complex only for a duration of the sanctioned work, a third subsystem which is fastened inside the borehole storage site and includes the lock device and a set of technological secondary containers in the form of caissons, in which the storage objects are arranged.

17. The apparatus for the method according to claim 15, wherein
the technological secondary containers in a form of caissons as part of the above-mentioned third functional subsystem are designed so that each caisson has an upper lid having openings, to which inner injection pipes are connected from below in an airtight manner, a lower cross-section of which is arranged in front of the lower lid of the caisson, the lower lid having openings, centers of the openings lying one above the other vertically with respect to the centers of the openings on the upper lid of the caisson and the storage objects being secured between the lids, which are connected to a cylindrical outer wall, inside the caisson.

18. The apparatus for the method according to claim 15, wherein
the lowermost caisson has a greatest calculated buoyancy, a positive importance of which is guaranteed structurally at all levels of submersion until resting on the bottom of the borehole, and no storage objects are secured in this caisson and it has a central support platform and a hydraulic damper.

19. The apparatus for the method according to claim 15, wherein
in a base region of the borehole, some of the pipe ducts fastened on the technological borehole pipe column and connected in an upper region to the hydraulic subsystem are secured by lower ends to a base plane of a pipe liner and form with an inner circumference of the borehole communicating vessels, and other pipe ducts which are connected to the external gas subsystem have at lower ends angular apertures for a sparging gas supplied in a jet through the technological fluid to the lower caisson, the gas being fed through the caisson continuously into all higher arranged caissons having storage objects, deep boreholes are formed with intermediate zones for blowing gas through the lower caisson, which are distributed in a depth of the borehole, and the zones have corresponding gas ducts with lower angular apertures for supplying the sparging gas to in the lower caisson.

20. The apparatus for the method according to claim 15, wherein
one or more pipe ducts which are connected to the hydraulic subsystem are connected to a separate pumping unit for periodically pumping the technological fluid out of the borehole from a submersion plane which is less than a size of a barometric column of the fluid.

21. The apparatus for the method according to claim 15, wherein
in the plane of the borehole mouth, in front of a sealed upper blocking closure, sliding supports are secured to prevent an uncontrollable rising of the loaded upper caisson and of the entire caisson assembly into a region of the lower blocking closure of the lock device.
